(19) United States
(12) Patent Application Publication
(10) Pub. No.: US 2014/0207260 A1
(43) Pub. Date: Jul. 24, 2014

(54) DATA CREATING DEVICE AND METHOD

(71) Applicant: Azbil Corporation, Tokyo (JP)

(72) Inventors: Hiroshi OHYAMA, Tokyo (JP); Naoyuki AKAI, Tokyo (JP)

(73) Assignee: AZBIL CORPORATION, Tokyo (JP)

(21) Appl. No.: 14/163,040

(22) Filed: Jan. 24, 2014

(30) Foreign Application Priority Data
Jan. 24, 2013 (JP) 2013-011105

(51) Int. Cl. G05B 15/02

(52) U.S. Cl. CPC G05B 15/02
USPC 700/83

(57) ABSTRACT

A data creating device includes an instrument control data generating portion that creates instrument definition data wherein fields for defining a field instrument in an instrument controlling device, including instrument tag information for the field instrument, are added to point definition data. The data creating device also includes a display controlling portion that controls creation and display of display data for inputting the instrument tag information into instrument tag information fields of the instrument definition data. The display data that is created by the display controlling portion is displayed on the displaying portion under control of the display controlling portion.

### CROSS REFERENCE TO RELATED APPLICATION

This application claims priority under 35 U.S.C. §119 to Japanese Patent Application No. 2013-011105, filed on Jan. 24, 2013, the entire content of which being hereby incorporated herein by reference.

### FIELD OF TECHNOLOGY

The present invention relates to a data creating device and method for creating setting data used in instrument controlling devices.

### BACKGROUND ART

Control systems are used in monitoring and control of various types of equipment ancillary to buildings, controlling plants, and the like, and instrument controlling devices are also used. See, for example, Japanese Unexamined Patent Application Publication No. 2012-014388. For example, in instrument controlling devices, signals are exchanged between field instruments, such as process instruments and various types of sensors, equipped in a work area, connected through a network such as a FieldBus, where, conventionally, mobile terminals would be used to connect directly to field instruments to set, from above, parameters for calibration, or to display diagnostic results relating to the proper operating state of a field instrument.

With such a control system and instrument controlling device, if, for example, there is a change in the configuration of that which is to be controlled, this produces engineering work in having to change the field instrument configuration that is set in the instrument controlling device. Such control can be applied to a large variety of instruments and, in the engineering work, the applicable data may be vast. Consequently, in the engineering work, work is performed to edit or changes data using tools (software) available on the market that have superior abilities for editing large amounts of data, where the new data that is produced is applied to controlling programs and field instrument configurations.

Moreover, at present network systems are also being developed wherein a digital signal is superimposed on an analog control signal to exchange, with the instrument controlling device, “additional information” such as secondary measurement values for the field instruments (for example, a temperature for performing temperature-pressure correction in a pressure gauge), setting parameters for the field instruments, and the like. Such network systems are known as HART (Highway Addressable Remote Transducer™) communication, where the use of instruments that are based on the HART communication standard is increasing.

Initially, the primary purpose was to set parameters for the field instruments, such as setting ranges using a HART communication compliant handheld terminal, but in recent years there have been advancements and standardization regarding self-diagnostics in field instruments. For example, monitoring field instrument self-diagnostics information on an “instrument controlling station,” which is added to, for example, an instrument controlling device, has also become one major objective. One of the engineering tasks in such a configuration is the work of confirming that both the communication between the controlling system and the field instrument, and the communication between the instrument controlling device and the field instrument, are functioning properly.

However, the confirmations described above are performed through the field instrument receiving both signals from the controlling system and signals from the instrument controlling device. For example, the technician goes to the location wherein a field instrument is installed and monitors the state of reception of signals by the field instruments. Because of this, the engineering work is time-consuming.

If here it were possible for the instrument controlling device to receive, through the field instrument, the signal that has been sent to the field instrument from the controlling system, in a state wherein the field instrument is identified, then the confirmations described above could be performed easily, without having to go to the location wherein the field instrument is installed. However, to do this it is necessary for the form identification of the field instrument in the controlling system to be recognized on the instrument controlling device side. In order to achieve this, it is necessary to add, to the instrument definition data that is used by the instrument controlling device, the field instrument identifying information (tag information) that is used by the controlling system.

However, because there is an extremely large number of field instruments involved, adding this information would require a tremendous amount of time. In this way, conventionally there has been a problem in that creating definition information for field instruments in an instrument controlling device for managing field instruments that are controlled by a controlling system has required time and labor.

The present invention was created in order to solve problems such as set forth above, and an aspect thereof is to be able to create, without requiring time and effort, field instrument definition information in an instrument controlling device for managing field instruments that are controlled by a controlling system.

### SUMMARY

The data creating device according to the present invention includes: a point definition data storing portion that stores point definition data indicating a connection status, including a field for connection tag information for an applicable instrument that is connected through a first network to a controlling system; an instrument control data generating portion that generates instrument definition data wherein a field for defining the applicable instrument in an instrument controlling device that is connected through a second network to the applicable instrument, including a field for instrument tag information for the applicable instrument, is added to the point information; an instrument definition data storing portion that stores the instrument definition data that is created by the instrument control data storing portion; a display controlling portion that creates and displays display data for inputting instrument tag information into a field for instrument tag information in the instrument definition data; a displaying portion that displays display data created by the display controlling portion; a data inputting portion that receives a data input relating to a field, including a field for the instrument tag information, of the instrument definition data; and a data setting portion that applies, to the instrument definition data that is stored in the instrument definition data storing portion, input data that has been received from the data inputting portion.

Moreover, a data creating method according to the present invention includes: a point definition data storing step for storing, in a point definition data storing portion, point definition data indicating a connection status, including a field for connection tag information for an applicable instrument that is connected through a first network to a controlling system; an instrument control data generating step for generating instrument definition data wherein a field for defining the applicable instrument in an instrument controlling device that is connected through a second network to the applicable instrument, including a field for instrument tag information for the applicable instrument, is added to the point information; an instrument definition data storing step for storing, in an instrument definition data storing portion, the instrument definition data that has been created in the instrument control data storing step; a display controlling step for creating and displaying display data for inputting instrument tag information into a field for instrument tag information in the instrument definition data; a displaying step for displaying display data created in the display controlling step; a data inputting step for receiving a data input relating to a field, including a field for the instrument tag information, of the instrument definition data; and a data setting step for applying, to the instrument definition data that is stored in the instrument definition data storing portion, input data that has been received in the data inputting step.

As explained above, the present invention provides the superior effects of being able to create, without requiring time and effort, field instrument definition information in an instrument controlling device for managing field instruments that are controlled by a controlling system.

BRIEF DESCRIPTIONS OF THE DRAWINGS

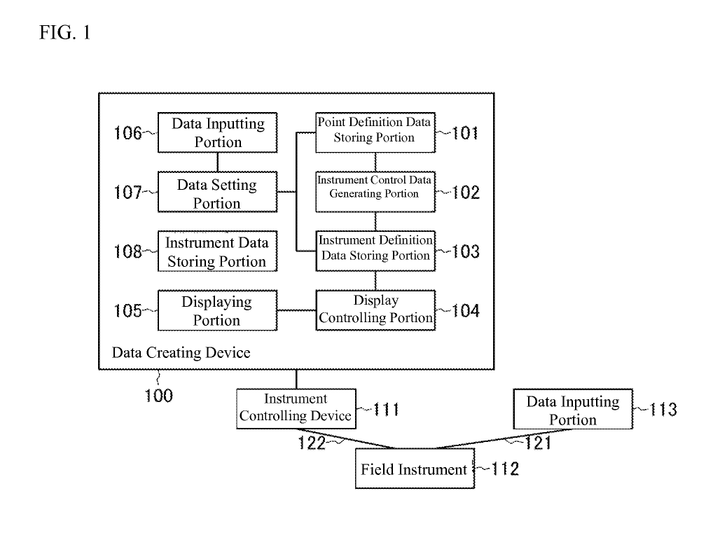

FIG. 1 is a structural diagram illustrating the structure of a data creating device 100 in an example according to the present invention.

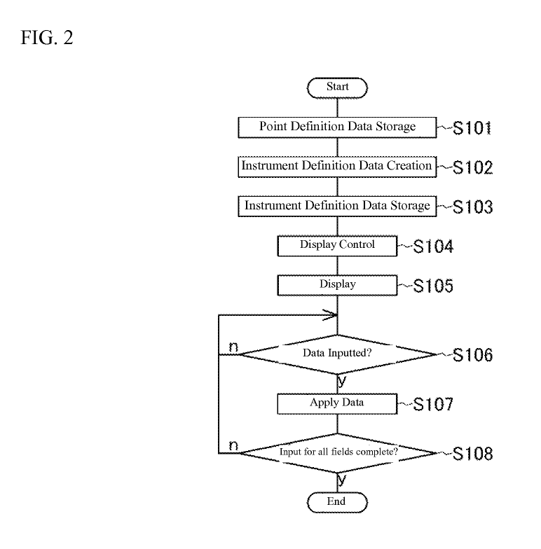

FIG. 2 is a flowchart for explaining the data creating method an example according to the present invention.

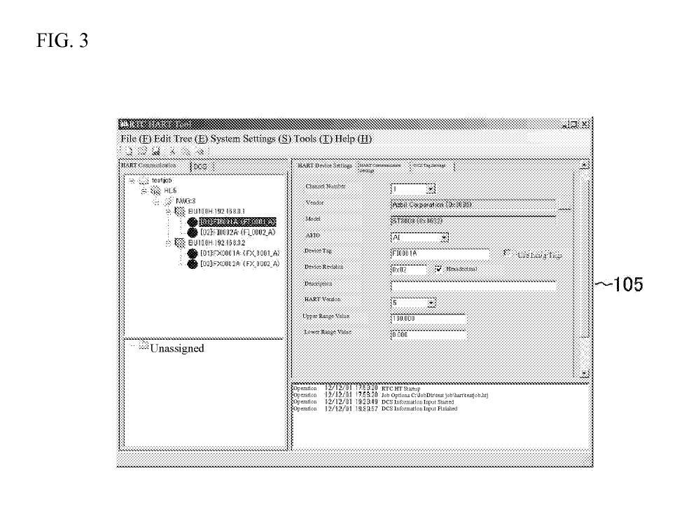

FIG. 3 is a structural diagram illustrating a state of the display on the displaying portion 105.

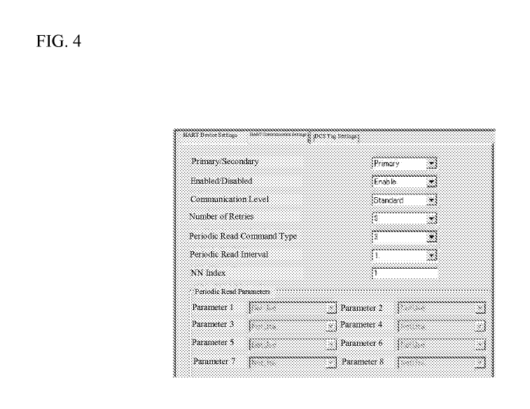

FIG. 4 is a structural diagram illustrating a state of the display.

### DETAILED DESCRIPTION

Forms for carrying out the present invention will be explained below in reference to the figures. FIG. 1 is a structural diagram illustrating the structure of a data creating device 100 in an example according to the present invention. The data creating device 100 includes: a point definition data storing portion 101, an instrument control data generating portion 102, an instrument definition data storing portion 103, a display controlling portion 104, a displaying portion 105, a data inputting portion 106, a data setting portion 107, and an instrument data storing portion 108.

An instrument controlling device 111 is connected to the data creating device 100, to perform instrument management of a field instrument 112 using the data created by the data creating device 100. Moreover, the field instrument 112 is controlled by a controlling system 113. Here the field instrument 112 is connected to the controlling system 113 through a network (a first network) 121. Moreover, the field instrument 112 is connected to the instrument controlling device 111 through a HART communication network (a second network) 122. Note that, although omitted from FIG. 1, multiple field instruments 112 are connected to each of the networks.

The point definition data storing portion 101 stores point definition data that indicates the connection status, including fields for the connection tag information, for an applicable field instrument 112. Point definition data, such as that which is shown in Table 1, below, is stored in the point definition data storing portion 101. In Table 1, “Point Tag” is part of the connection tag information. “Type” indicates the type of field instrument 112. The “Controller No.,” “IOM (I/O Module) No.,” and “Slot No.” are connection assignment information for a field instrument 112 on the network 121. Moreover, the “Industrial Units,” “PV (Process Value) Upper Limit Range,” and “PV Lower Limit Range” are process information for the field instrument 112.

TABLE 1

| | | Control | IOM | Slot | Industrial | PV Upper | PV Lower | |
|---|---|---|---|---|---|---|---|---|
| Point Tag | Type | No. | No. | No. | Units | Limit Range | Limit Range | ... |
| FI_0001_A | AI | 11 | 1 | 1 | L/min | 50 | 0 | ... |
| FI_0002_A | AI | 11 | 1 | 2 | ml/sec | 200 | 0 | ... |
| FX_0001_A | AO | 11 | 2 | 1 | | 100 | 0 | ... |
| FX_0102_A | AO | 12 | 5 | 7 | | 100 | 0 | ... |

The instrument control data generating portion 102 creates instrument definition data wherein fields for defining the field instrument 112 in the instrument controlling device 111, including the instrument tag information for the field instrument 112, are added to the point definition data.

The instrument definition data storing portion 103 stores the instrument definition data that is created by the instrument control data generating portion 102. For example, instrument definition data such as shown in Table 2, below, is created by the instrument control data generating portion 102 and stored in the instrument definition data storing portion 103. In the example below, “Device Tag,” which is a field for instrument tag information for identifying the field instrument 112 in the instrument controlling device 111, “Vendor,” which is a field for identifying the manufacturer of the field instrument 112, “Device Type,” which is a field for specifying the type of the field instrument 112, and “HART Version,” which is a field indicating the version of HART communication that is used have been added.

TABLE 2

| Device | | Device | HART | | Point | Control | IOM | Slot | |
|---|---|---|---|---|---|---|---|---|---|
| Tag | Vendor | Type | Version | Point Tag | Type | No. | No. | No. | |
| | | | | FI_0001_A | AI | 11 | 1 | 1 | ... |
| | | | | FI_0002_A | AI | 11 | 1 | 2 | ... |
| | | | | FX_0001_A | AO | 11 | 2 | 1 | ... |
| | | | | FX_0102_A | AO | 12 | 5 | 7 | ... |

The display controlling portion 104 controls the creation and display of display data for inputting the instrument tag information into the instrument tag information fields of the instrument definition data. The display data that is created by the display controlling portion 104 is displayed on the displaying portion 105 under the control of the display controlling portion 104.

The data inputting portion 106 is, for example, a keyboard, or the like, and receives various types of data inputs through user operations. The data that is received (inputted) is data for the fields, including the instrument tag information fields for the instrument definition data. The input data that has been received by the data inputting portion 106 in this way is applied to the instrument definition data that the data setting portion 107 stores in the instrument definition data storing portion 103.

For example, display data requesting the input of device data is displayed on the displaying portion 105 under the control of the display controlling portion 104. Given this display data, connection tag information (point tags) are displayed for each individual record. There is a one-to-one correspondence between records and field instruments. The user, in response to the display requesting this input, inputs the instrument tag information (the device tag) for each record.

The data creating device 100 (the data setting portion 107), through the inputting operation by the user, reads out, from the instrument data storing portion 108, data for the “Vendor,” “Device Type,” and “HART Version,” corresponding to the device tag that has been inputted. The vendor information, device type, and HART version corresponding to the device tag are stored in the instrument data storing portion 108. In this way, the data that is inputted through the user operation and the data that is read out from the instrument data storing portion 108 are combined, to complete the instrument definition data, as illustrated in Table 3, below. Note that for each of the individual fields that have been added, data that is inputted by the user can be included.

TABLE 3

| Device | | Device | HART | | Point | Control | IOM | Slot | |
|---|---|---|---|---|---|---|---|---|---|
| Tag | Vendor | Type | Version | Point Tag | Type | No. | No. | No. | |
| FI0001A | 0036 | 3602 | 5 | FI_0001_A | AI | 11 | 1 | 1 | ... |
| FI0002A | 0036 | 360D | 6 | FI_0002_A | AI | 11 | 1 | 2 | ... |
| FX0001A | 0036 | 3614 | 5 | FX_0001_A | AO | 11 | 2 | 1 | ... |
| FX0002A | 0036 | 360F | 7 | FX_0102_A | AO | 12 | 5 | 7 | ... |

The operation of the data creating device in an example according to the present invention (a data creating method) will be explained using the flowchart in FIG. 2.

First, in Step S101, point definition data indicating the connection status, including the fields for the connection tag information of the field instrument 112, is stored in the point definition data storing portion 101 (point definition data storing step). For example, point definition data is stored into the point definition data storing portion 101 through the user operating the data inputting portion 106.

Following this, in Step S102, the instrument control data generating portion 102 generates instrument definition data that adds, to the point definition data, fields for defining the field instrument 112 in the instrument controlling device 111, including the fields for the instrument tag information of the field instrument 112 (instrument control data generating step).

Following this, in Step S103, the instrument control data generating portion 102 stores, into the instrument definition data storing portion 103, the instrument definition data that was generated in Step S102 (instrument definition data storing step).

Following this, in Step S104, the display controlling portion 104 performs control of the display, such as generating display data for inputting instrument tag information into the instrument tag information fields in the instrument definition data (display creating step). Following this, in Step S105, the display data that was created in Step S104 is displayed on the displaying portion 105 (displaying step). For example, as illustrated in FIG. 3, a display for inputting data (a window display) is formed on the displaying portion 105. In this display, the inputting of at least a device tag is requested.

Following this, in Step S106, the data inputting portion 106 receives data input in relation to fields including fields for the instrument tag information in the instrument definition data (data inputting step). For example, the device awaits data input, by the user operating the data inputting portion 106, for any of the fields displayed, as illustrated in FIG. 3.

When here data has been inputted (Step S106: y), then, in Step S107, the inputted data is applied to the instrument definition data that is stored in the instrument definition data storing portion 103 (data setting step). At this time, if there has been data input into the field for the device tag, through a user operation, then the data for the “Vendor,” “Device Type,” and “HART Version” corresponding to the inputted device tag are read out from the instrument data storing portion 108 by the data setting portion 107 and combined automatically.

Moreover, if, for example, the “HART Communication Settings” tag is selected in the display illustrated in FIG. 3, then, as illustrated in FIG. 4, the “HART Communication Settings” mode display will be displayed, enabling inputting of data corresponding to the HART communication settings. The operation is completed when input has been provided for all of the fields, as described above (Step S108: y).

As described above, in the present invention instrument definition data is created wherein fields for defining the applicable instrument in the instrument controlling device are added to the point definition data that is used by the controlling system, thus making it possible to create, without time and effort, definition information for field instruments in the instrument controlling device for managing the field instruments that are controlled by the controlling system.

Moreover, the identification information for a field instrument, used in the controlling system, is understood on the instrument controlling device side, through the use of this instrument definition data, enabling the loop checks to be performed by the instrument controlling device, through a HART signal, so as to confirm whether or not instruction values used in control by the controlling system, have been received properly by the field instrument. Performing such a loop check eliminates the need to go to the location wherein the field instrument is installed, thus making it possible to reduce the time and effort in engineering.

Note that the present invention is not limited to the examples set forth above, but rather, of course, many changes and combinations can be made by one of ordinary skill in the art, within the range of the technical concept of the present invention.

1. A data creating device comprising:
a point definition data storing portion that stores point definition data indicating a connection status, including a field for connection tag information for an applicable instrument that is connected through a first network to a controlling system;
an instrument control data generating portion that generates instrument definition data wherein a field for defining the applicable instrument in an instrument controlling device that is connected through a second network to the applicable instrument, including a field for instrument tag information for the applicable instrument, is added to point information;
an instrument definition data storing portion that stores the instrument definition data that is created by the instrument control data storing portion;
a display controlling portion that creates and displays display data for inputting instrument tag information into a field for instrument tag information in the instrument definition data;
a displaying portion that displays display data created by the display controlling portion;
a data inputting portion that receives a data input relating to a field, including a field for the instrument tag information, of the instrument definition data; and
a data setting portion that applies, to the instrument definition data that is stored in the instrument definition data storing portion, input data that has been received from the data inputting portion.

2. A data creating method comprising:
a point definition data storing step for storing, in a point definition data storing portion, point definition data indicating a connection status, including a field for connection tag information for an applicable instrument that is connected through a first network to a controlling system;
an instrument control data generating step for generating instrument definition data wherein a field for defining the applicable instrument in an instrument controlling device that is connected through a second network to the applicable instrument, including a field for instrument tag information for the applicable instrument, is added to the point information;
an instrument definition data storing step for storing, in an instrument definition data storing portion, the instrument definition data that has been created in the instrument control data storing step;
a display controlling step for creating and displaying display data for inputting instrument tag information into a field for instrument tag information in the instrument definition data;
a displaying step for displaying display data created in the display controlling step;
a data inputting step for receiving a data input relating to a field, including a field for the instrument tag information, of the instrument definition data; and
a data setting step for applying, to the instrument definition data that is stored in the instrument definition data storing portion, input data that has been received in the data inputting step.
